(19) United States
(12) Patent Application Publication
(10) Pub. No.: US 2025/0196331 A1
(43) Pub. Date: Jun. 19, 2025

(54) ROBOT SYSTEM, PROCESSING METHOD, AND RECORDING MEDIUM

(71) Applicant: NEC Corporation, Minato-ku, Tokyo (JP)

(72) Inventors: Yukihiro Kiuchi, Tokyo (JP); Masatsugu Ogawa, Tokyo (JP); Tsutomu Maruyama, Tokyo (JP); Youko Mori, Tokyo (JP); Hiromi Muto, Tokyo (JP); Hidekazu Nagaoka, Tokyo (JP)

(73) Assignee: NEC Corporation, Minato-ku, Tokyo (JP)

(21) Appl. No.: 18/847,755

(22) PCT Filed: Mar. 29, 2022
(86) PCT No.: PCT/JP2022/015724

§ 371 Date: Sep. 17, 2024

(51) Int. Cl. B25J 9/16; B25J 18/00

(52) U.S. Cl. CPC B25J 9/161; B25J 9/163; B25J 9/1697; B25J 18/00

(57) ABSTRACT

A robot system includes a robot arm configured to be able to grasp a target object including a packaging member with transparency and a physical object packaged by the packaging member, a memory configured to store instructions; and a processor. The processor is configured to execute the instructions to: identify a type of the physical object based on image processing on an image of the target object, and make a change to an environment different from an environment in which the image of the target object has been captured in a case where the type of the physical object has not been identified.

### TECHNICAL FIELD

The present disclosure relates to a robot system, a processing method, and a recording medium.

### BACKGROUND ART

Robots are used in various fields such as logistics. Patent Documents 1 and 2 disclose technologies related to a robot system for grasping a physical object as related technology.

### PRIOR ART DOCUMENTS

### Patent Document

Patent Document 1: Japanese Unexamined Patent Application, First Publication No. 2018-176334
Patent Document 2: Japanese Patent No. 6752615

### SUMMARY

### Technical Problem

Meanwhile, in an image obtained by capturing a physical object such as a product covered with a packaging member with transparency, the reflection of light by the packaging member, the reflection of a nearby physical object, or the like is likely to occur. Therefore, it may be difficult to identify a physical object from such an image. Even if a robot disclosed in Patent Document 1 and Patent Document 2 is used, because a physical object cannot be accurately recognized in such a situation, an appropriate operation cannot be performed on the physical object.

An objective of each example aspect of the present disclosure is to provide a robot system, a processing method, and a recording medium capable of solving the above-described problems.

### Solution to Problem

According to an example aspect of the present disclosure, there is provided a robot system including: a robot arm configured to be able to grasp a target object including a packaging member with transparency and a physical object packaged by the packaging member; a drive means configured to drive the robot arm; an identification means configured to identify a type of the physical object based on image processing on an image of the target object; and a change means configured to make a change to an environment different from an environment in which the image of the target object has been captured in a case where the identification means has not identified the type of the physical object.

According to another example aspect of the present disclosure, there is provided a processing method to be performed by a robot system including a robot arm configured to be able to grasp a target object including a packaging member with transparency and a physical object packaged by the packaging member, the processing method including: driving the robot arm; identifying a type of the physical object based on image processing on an image of the target object; and making a change to an environment different from an environment in which the image of the target object has been captured in a case where the type of the physical object has not been identified.

According to yet another example aspect of the present disclosure, there is provided a recording medium storing a program for causing a computer, which includes a robot system including a robot arm configured to be able to grasp a target object including a packaging member with transparency and a physical object packaged by the packaging member, to: drive the robot arm; identify a type of the physical object based on image processing on an image of the target object; and make a change to an environment different from an environment in which the image of the target object has been captured in a case where the type of the physical object has not been identified.

According to yet another example aspect of the present disclosure, there is provided a robot system including: a robot arm; and a control means configured to control an operation of the robot arm so that the robot arm performs an operation on a target object based on a result of recognizing an image obtained from an imaging device capturing the target object, wherein the target object is a physical object packaged by a packaging member with transparency, and wherein the control means controls the robot arm so that an environment in which the imaging device captures the target object is changed in a case where the physical object has not been identified from the image.

### Advantageous Effects of Invention

According to each example aspect of the present disclosure, even if a physical object is packaged by a packaging member with transparency, the physical object can be appropriately and accurately recognized.

### BRIEF DESCRIPTION OF DRAWINGS

FIG. 1 is a diagram showing an example of a configuration of a robot system according to a first example embodiment of the present disclosure.

FIG. 2 is a diagram showing an example of a database according to the first example embodiment of the present disclosure.

FIG. 3 is a diagram showing an example of a configuration of a processing device according to the first example embodiment of the present disclosure.

FIG. 4 is a diagram showing an example of a configuration of a processing unit according to the first example embodiment of the present disclosure.

FIG. 5 is a diagram showing an example of teacher data in the first example embodiment of the present disclosure.

FIG. 6 is a flowchart showing an example of a processing flow of the robot system according to the first example embodiment of the present disclosure.

FIG. 7 is a diagram showing an example of a configuration of a robot according to a first modified example of the first example embodiment.

FIG. 8 is a diagram showing an example of a data table in a modified example of a second example embodiment of the present disclosure.

FIG. 9 is a diagram showing a robot system having a minimum configuration according to an example embodiment of the present disclosure.

FIG. 10 is a flowchart showing an example of a processing flow of the robot system with the minimum configuration.

FIG. 11 is a schematic block diagram showing a configuration of a computer according to at least one example embodiment.

### EXAMPLE EMBODIMENT

Hereinafter, example embodiments will be described in detail with reference to the drawings. A robot system 1 according to each example embodiment of the present disclosure can change an environment in which a physical object (e.g., a product) packaged by a packaging member with transparency is captured to an environment in which an image for identifying the physical object can be captured. This change in the environment includes an operation of a robot 20 on the packaging member such as extending the packaging member in the robot system 1 to be described below or an operation of the robot 20 for changing a state of the physical object such as changing an orientation of the physical object.

### First Example Embodiment

The robot system 1 according to a first example embodiment of the present disclosure can appropriately and accurately recognize a physical object (e.g., a product) even if the physical object is packaged by a packaging member with transparency. Examples of the packaging member with transparency include plastic wrap, vinyl, plastic containers, and the like. The robot system 1 identifies a target object to be gripped (or grasped) from a plurality of types of physical objects based on image processing on a captured image. In addition, in the present disclosure, grasping includes holding a physical object at a position of a robot arm by suctioning the physical object as well as holding a physical object at a position of a robot arm by pinching the physical object. The robot system 1 may identify a target object on which an operation is performed from a plurality of types of physical objects based on the image processing on the captured image. The operation may not be grasping as described above, and may be, for example, rotating, moving, opening, boxing, or the like. The operation is not limited to the above-described examples. The robot system 1 is used, for example, in a warehouse, a food factory, a supermarket, a convenience store, and the like.

### (Configuration of Robot System)

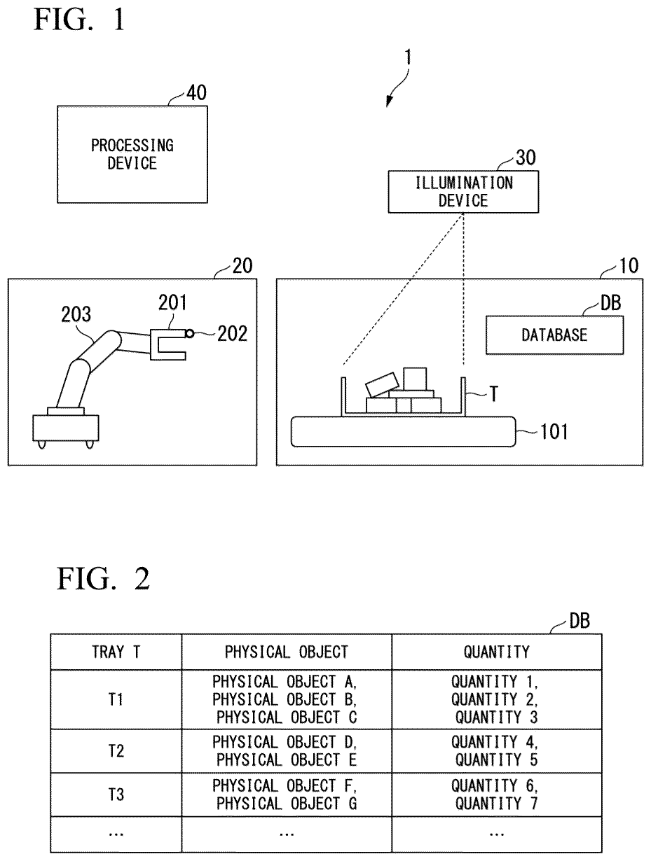

FIG. 1 is a diagram showing an example of a configuration of the robot system 1 according to the first example embodiment of the present disclosure. As shown in FIG. 1, the robot system 1 includes a transport device 10, a robot 20, an illumination device 30 (an example of an illumination means), and a processing device 40.

As shown in FIG. 1, the transport device 10 includes a transport mechanism 101, a tray T, and a database DB. Based on the database DB, the transport mechanism 101 places a plurality of types of physical objects (e.g., products) packaged by a packaging member with transparency on the tray T and moves the plurality of types of physical objects to a position where the robot 20 can grasp. For example, products (e.g., product A, product B, and product C) arriving at a warehouse, a food factory, a supermarket, a convenience store, or the like are placed in the tray T and information indicating types of the products arriving thereat and the number of products is recorded in the database DB for each tray T. FIG. 2 is a diagram showing an example of the database DB according to the first example embodiment of the present disclosure. In an example of the database DB shown in FIG. 2, it is indicated that three types of product A, product B, and product C are placed on a tray T1, and one product A, two products B, and three products C are present. In a case where product A is grasped as a physical object by the robot 20, the transport mechanism 101 identifies the tray T1 associated with product Ain the database DB. Also, the transport mechanism 101 moves the tray T1 to a position where the robot 20 can grasp.

As shown in FIG. 1, the robot 20 includes a robot arm 201, an imaging device 202 (an example of a capturing means), and a drive mechanism 203 (an example of a drive means). The robot arm 201 grasps a physical object in accordance with an operation of the drive mechanism 203. The imaging device 202 captures the physical object in the tray T. For example, the imaging device 202 captures a plurality of types of physical objects (e.g., products) packaged by a packaging member with transparency, a barcode or a tag indicating a physical object attached to a physical object, or the like. Examples of the imaging device 202 include a camera, a video camera, and the like. The drive mechanism 203 operates the robot arm 201 under control of the processing device 40. The illumination device 30 illuminates a physical object placed on the tray T.

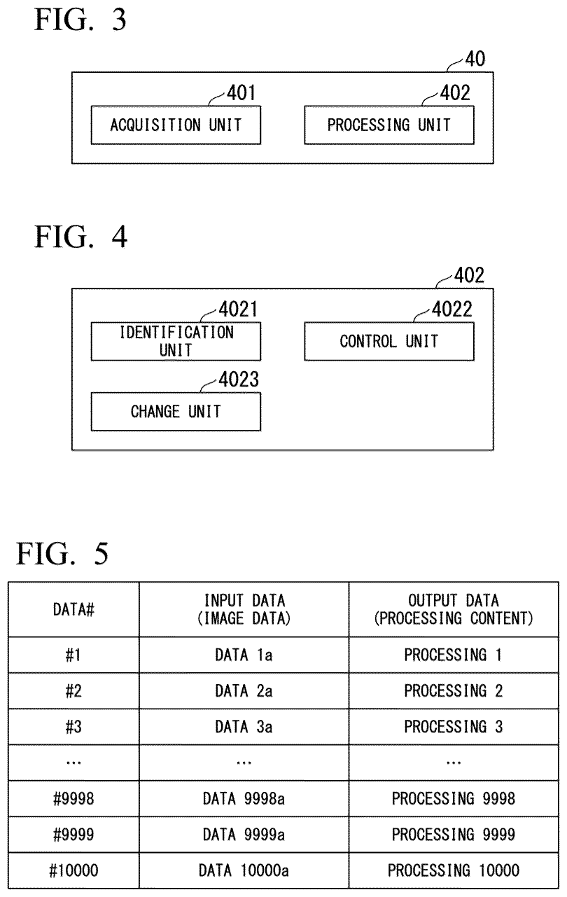

FIG. 3 is a diagram showing an example of a configuration of the processing device 40 according to the first example embodiment of the present disclosure. As shown in FIG. 3, the processing device 40 includes an acquisition unit 401 and a processing unit 402. The acquisition unit 401 acquires an image of a physical object captured by the imaging device 202.

FIG. 4 is a diagram showing an example of a configuration of the processing unit 402 according to the first example embodiment of the present disclosure. As shown in FIG. 4, the processing unit 402 includes an identification unit 4021 (an example of an identification means), a control unit 4022 (an example of a control means), and a change unit 4023 (an example of a change means and an example of a control means).

The identification unit 4021 identifies a type of a physical object based on an image of the physical object acquired by the acquisition unit 401 (i.e., the image of the physical object captured by the imaging device 202). For example, the identification unit 4021 compares an image of each of a plurality of types of physical objects prepared in advance with the image of the physical object acquired by the acquisition unit 401. The identification unit 4021 identifies the type of the physical object in the image acquired by the acquisition unit 401 based on a comparison result. Alternatively, the identification unit 4021 determines that the type of the physical object cannot be identified based on the comparison result. For example, the identification unit 4021 may identify the type of the physical object in the image by applying a model created in machine learning such as a neural network to the image acquired by the acquisition unit 401. Moreover, for example, the identification unit 4021 may identify that the physical object indicated in the image acquired by the acquisition unit 401 is a physical object indicated in a pre-prepared image with the largest number of matching image portions. Moreover, for example, the identification unit 4021 reads a barcode, a tag, or the like attached to a physical object indicated in the image acquired by the acquisition unit 401. In a case where the identification unit 4021 can identify a physical object in a reading process, the physical object indicated in the image acquired by the acquisition unit 401 may be identified as the physical object. In other words, the above-described process can be said to be a process in which the identification unit 4021 analyzes the image and executes an operation of recognizing the physical object reflected in the image.

In a case where the identification unit 4021 can identify the type of the physical object indicated in the image acquired by the acquisition unit 401, the control unit 4022 controls the drive mechanism 203 so that the drive mechanism 203 is allowed to grasp the identified physical object. In other words, the above-described process is a process in which the control unit 4022 controls the operation of the robot arm 201 based on a recognition result so that the robot arm 201 performs an operation (e.g., a grasping operation) on the target object in a case where the physical object can be recognized from the image.

In a case where the identification unit 4021 has not identified the type of the physical object indicated in the image acquired by the acquisition unit 401, the change unit 4023 makes a change to an environment different from an environment in which the image has been captured. Examples of causes for which the identification unit 4021 has not identified the type of the physical object indicated in the image acquired by the acquisition unit 401 include a refractive index of a transparent packaging material, the reflection (a light source or reflection) on a surface of the transparent packaging material, a position or orientation of a physical object within the transparent packaging material, and the like.

Moreover, the following content is examples of processing content for eliminating the inability of the identification unit 4021 to identify the type of the physical object indicated in the image acquired by the acquisition unit 401. For example, in a case where the identification unit 4021 has not identified the type of the physical object indicated in the image acquired by the acquisition unit 401, the change unit 4023 controls the imaging device 202 to form an angle different from an angle of the imaging device 202 by which the image of the physical object (i.e., the target object) has been captured.

Moreover, for example, in a case where the identification unit 4021 has not identified the type of the physical object indicated in the image acquired by the acquisition unit 401, the change unit 4023 makes a change to a state of light different from a state of light radiated to the physical object in a state in which the image of the physical object (i.e., the target object) has been captured. Specifically, in a case where the identification unit 4021 has not identified the type of the physical object indicated in the image acquired by the acquisition unit 401, the change unit 4023 makes a change to an angle of light different from an angle of light radiated to the physical object (i.e., the target object) in a state in which the image of the physical object has been captured. Moreover, specifically, in a case where the identification unit 4021 has not identified the type of the physical object indicated in the image acquired by the acquisition unit 401, the change unit 4023 causes a physical object for changing a refractive index of light between a physical object (i.e., a target object) and the illumination device 30 to move. Moreover, specifically, in a case where the identification unit 4021 has not identified the type of the physical object indicated in the image acquired by the acquisition unit 401, the change unit 4023 controls the drive mechanism 203 so that a state of a physical object (i.e., a target object) changes. More specifically, for example, in a case where the identification unit 4021 has not identified the type of the physical object indicated in the image acquired by the acquisition unit 401, the change unit 4023 controls the drive mechanism 203 so that an orientation of a physical object (i.e., a target object) changes. More specifically, for example, in a case where the identification unit 4021 has not identified the type of the physical object indicated in the image acquired by the acquisition unit 401, the change unit 4023 controls the drive mechanism 203 so that a state of the packaging member changes. More specifically, for example, in a case where the identification unit 4021 has not identified the type of the physical object indicated in the image acquired by the acquisition unit 401, the change unit 4023 controls the drive mechanism 203 so that swelling of the packaging member is pressed. More specifically, for example, in a case where the identification unit 4021 has not identified the type of the physical object indicated in the image acquired by the acquisition unit 401, the change unit 4023 controls the drive mechanism 203 so that the packaging member is stretched.

Moreover, a process of the change unit 4023 may be implemented by the control unit 4022 controlling an operation of the robot arm 201. In a case where the target object is a physical object packaged by a packaging member with transparency, the above-described process can be a process in which the control unit 4022 controls the operation of the robot arm 201 so that the environment in which the imaging device captures the target object is changed in a case where the physical object cannot be recognized from the image.

In addition, in a case where the identification unit 4021 has not identified the type of the physical object indicated in the image acquired by the acquisition unit 401, the above-described process of making a change to an environment different from the environment in which the image of the physical object (i.e., the target object) has been captured to be performed by the change unit 4023 may be performed on the basis of a learned model in which a coefficient has been decided in a supervised learning method.

For example, the change unit 4023 predicts processing content of a case where the identification unit 4021 has not identified a type of physical object indicated in an image acquired by the acquisition unit 401 by using a learned model (e.g., a convolutional neural network) in which parameters are decided using teacher data in one type of machine learning. Here, the learned model used by the change unit 4023 for each prediction process will be described.

### (Learned Model)

The learned model will be described. The change unit 4023 predicts processing content on the basis of an image of a physical object acquired by the acquisition unit 401 (i.e., an image of a physical object captured by the imaging device 202). Here, a learned model of a case where the change unit 4023 predicts processing content on the basis of an image of a physical object acquired by the acquisition unit 401 (i.e., an image of a physical object captured by the imaging device 202) will be described.

In this case, image data of the physical object captured by the imaging device 202 becomes one input. Moreover, processing content actually set for the image data is one output data item. Also, a combination of input data and output data corresponding to the input data is one teacher data item. For example, before the processing content is predicted by the change unit 4023, output data (i.e., the processing content actually set for the image data of the physical object captured by the imaging device 202) is identified for the input data used by the other device to predict the processing content. Alternatively, for example, by performing an experiment or simulation, the output data is identified for the input data. In this way, it is possible to prepare teacher data including a plurality of data items obtained by combining input data and output data. The teacher data is data used to decide a value of a parameter in a learning model in which the value of the parameter has not been decided.

FIG. 5 is a diagram showing an example of teacher data in the first example embodiment of the present disclosure. The input data, which is the image data of the physical object, and the output data (i.e., the processing content) for the input data are a set of data. In the example shown in FIG. 5, the teacher data includes 10,000 sets of data.

For example, a case where parameters in a learning model are decided using teacher data including 10,000 sets of data shown in FIG. 5 is considered. In this case, the teacher data is divided into, for example, training data, validation data, and test data. Examples of proportions of training data, evaluation data, and test data include 70%, 15%, and 15%, 95%, 2.5%, and 2.5%, or the like. For example, it is assumed that the teacher data of data #1 to #10000 is divided into data #1 to #7000 as training data, data #7001 to #8500 as evaluation data, and data #8501 to #10000 as test data of 15%. In this case, data #1, which is training data, is input to a convolutional neural network, which is a learning model. The convolutional neural network outputs the processing content actually set for the image data of the physical object. Every time the input data of the training data is input to the convolutional neural network, and the processing content actually set for the image data of the physical object is output from the convolutional neural network (in this case, every time each data item of data #1 to #7000 is input into the convolutional neural network), for example, a backpropagation process is performed in accordance with the output, such that a parameter indicating the weighting of a data connection between nodes is changed (i.e. a model of the convolutional neural network is changed). In this way, training data is input into the neural network and parameters are adjusted.

Next, input data (data #7001 to #8500) of evaluation data is sequentially input to the convolutional neural network whose parameters have been changed by the training data. The convolutional neural network outputs the processing content actually set for the image data of the physical object in accordance with the input evaluation data. Here, in a case where data output by the convolutional neural network is different from the output data associated with the input data in FIG. 5, the parameters are changed so that the output of the convolutional neural network is the output data associated with the input data in FIG. 5. Thus, a convolutional neural network (i.e., a learning model) whose parameters have been decided is a learned model.

Next, input data of test data (data #8501 to #10000) is sequentially input to the convolutional neural network of the learned model as the final confirmation. The convolutional neural network of the learned model outputs the processing content actually set for the image data of the physical object in accordance with the input test data. For all test data, in a case where the output data output by the convolutional neural network of the learned model matches the output data associated with the input data in FIG. 5, the convolutional neural network of the learned model is a desired model. Moreover, in a case where the output data output by the convolutional neural network of the learned model does not match the output data associated with the input data in FIG. 5 in any one item of the test data, parameters of the learning model are decided using new teacher data. The decision of the parameters of the learning model described above is iterated until a learned model with desired parameters is obtained. In a case where a learned model with the desired parameters has been obtained, this learned model is recorded in the change unit 4023. Also, the change unit 4023 may predict the processing content using this learned model.

### (Process Performed by Robot System)

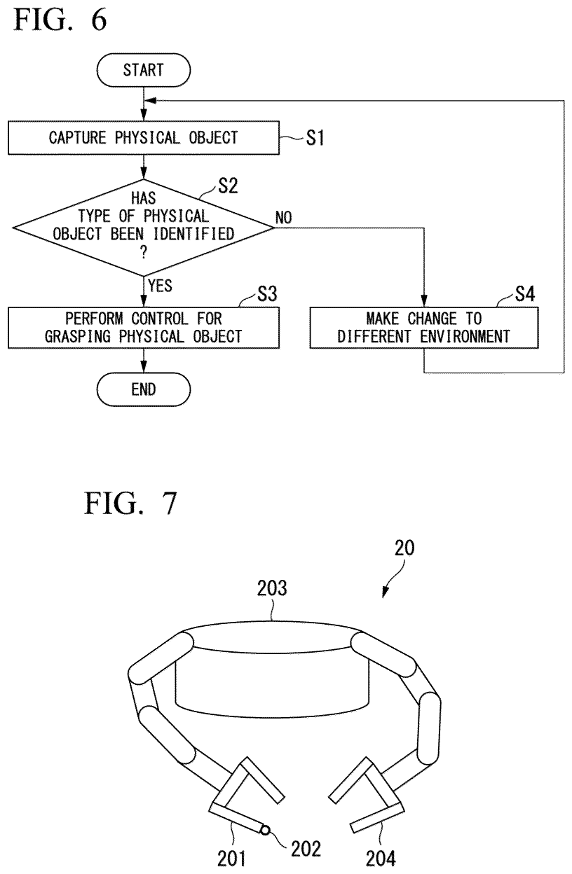

FIG. 6 is a diagram showing an example of a processing flow of the robot system 1 according to the first example embodiment of the present disclosure. Next, the process performed by the robot system 1 will be described with reference to FIG. 6.

The imaging device 202 captures a physical object in the tray T (step S1). For example, the imaging device 202 captures a plurality of types of physical objects (e.g., products) packaged by a packaging member with transparency, or a barcode, a tag, or the like indicating what a physical object attached to a physical object is.

The identification unit 4021 identifies a type of the physical object based on the image of the physical object acquired by the acquisition unit 401 (i.e., the image of the physical object captured by the imaging device 202) (step S2). For example, the identification unit 4021 compares an image of each of the plurality of types of physical objects prepared in advance with the image of the physical object acquired by the acquisition unit 401. Also, the identification unit 4021 identifies that the physical object indicated in the image acquired by the acquisition unit 401 is a physical object indicated in a prepared image in advance with the largest number of matching image portions. Moreover, for example, the identification unit 4021 reads a barcode, a tag, or the like attached to a physical object indicated in the image acquired by the acquisition unit 401. Also, in a case where the identification unit 4021 can identify a physical object in a reading process, the physical object indicated in the image acquired by the acquisition unit 401 is identified as the physical object.

In a case where the identification unit 4021 has identified a type of the physical object indicated in the image acquired by the acquisition unit 401 (YES in step S2), the control unit 4022 controls the drive mechanism 203 so that the drive mechanism 203 grasps the identified physical object (step S3).

In a case where the identification unit 4021 has not identified a type of the physical object indicated in the image acquired by the acquisition unit 401 (NO in step S2), the change unit 4023 makes a change to an environment different from the environment in which the image has been captured (step S4). For example, the change unit 4023 predicts processing content using the learned model. The change unit 4023 makes the change to an environment different from the environment in which the image has been captured based on the predicted processing content. Also, the change unit 4023 returns to the processing of step S1.

### (Advantage)

The robot system 1 according to the first example embodiment of the present disclosure has been described above. The robot system 1 includes the robot arm 201 configured to be able to grasp a target object including a packaging member with transparency and a physical object packaged by the packaging member. In the robot system 1, the drive mechanism 203 drives the robot arm 201. The identification unit 4021 identifies a type of the physical object based on image processing on the image of the target object. In a case where the identification unit 4021 has not identified the type of the physical object, the change unit 4023 makes a change to an environment different from an environment in which the image of the target object has been captured.

The robot system 1 can change an environment in which the imaging device 202 captures a physical object. Due to this change in the environment, the image of the physical object captured by the imaging device 202 changes. As a result, there is a possibility that the image of the physical object captured by the imaging device 202 will be improved to an extent that the physical object can be identified.

### First Modified Example of First Example Embodiment

Next, a robot system 1 according to a first modified example of the first example embodiment of the present disclosure will be described. FIG. 7 is a diagram showing an example of a configuration of a robot 20 according to the first modified example of the first example embodiment. In the first example embodiment, the robot 20 has been described as a robot with a single arm including the robot arm 201. However, in the first modified example of the first example embodiment, the robot 20 may include a robot arm 204 (an example of a second robot arm) separate from the robot arm 201 as shown in FIG. 7. Moreover, the number of robot arms 204 may be two or more. In this case, the change unit 4023 may cause the robot arm 204 to move as a physical object that changes a refractive index of light between the physical object (i.e., the target object) and the illumination device 30 in a case where the identification unit 4021 has not identified the type of the physical object indicated in the image acquired by the acquisition unit 401. In the robot system 1 including the robot 20, the robot arm 204 can be used as a physical object that changes the refractive index of light. As a result, there is a possibility of improvement to the extent that the physical object can be identified.

### Second Modified Example of First Example Embodiment

Next, a robot system 1 according to a second modified example of the first example embodiment of the present disclosure will be described. In the second modified example of the first example embodiment of the present disclosure, a change unit 4023 of a processing device 40 may store a corresponding relationship between an image and processing content performed after changing the environment. Also, the change unit 4023 of the processing device 40 may perform additional learning to change a parameter of the learned model using the corresponding relationship between the stored processing content and the image as input data. That is, the learned model may be changed based on the changed environment. In addition, this additional learning may be performed in real time at a timing in a case where the processing content is implemented. Moreover, this additional learning may also be performed after a certain number of data items are collected. Moreover, this additional learning may use data of the robot system 1 located at another location. In the robot system 1 including a robot 20, a learned model in which parameters are decided based on the latest processing data can be used. As a result, it can be expected that the accuracy of identification of the physical object by the image of the physical object captured by an imaging device 202 can be improved.

### Second Example Embodiment

Next, a robot system 1 according to a second example embodiment of the present disclosure will be described. The robot system 1 includes a transport device 10, a robot 20, an illumination device 30, and a processing device 40 like the robot system 1 according to the first example embodiment of the present disclosure shown in FIG. 1. The processing device 40 includes an acquisition unit 401 and a processing unit 402 like the processing device 40 according to the first example embodiment of the present disclosure shown in FIG. 3. The processing unit 402 includes an identification unit 4021 (an example of an identification means), a control unit 4022, and a change unit 4023 (an example of a change means) like the processing unit 402 according to the first example embodiment of the present disclosure shown in FIG. 4. In the first example embodiment of the present disclosure, the change unit 4023 for predicting the processing content using the learned model has been described. However, in the second example embodiment of the present disclosure, the change unit 4023 tries to make a change to an environment different from an environment in which the image has been captured by trying to perform the processing content by trial and error. That is, the change unit 4023 performs first processing content in a case where the identification unit 4021 has not identified the type of the physical object indicated in the image acquired by the acquisition unit 401 and performs second processing content different from the first processing content in a case where the identification unit 4021 has not identified the type of the physical object from an image obtained by capturing the target object after the first processing content is performed. For example, in a case where there are five processing content items, i.e., processing A, processing B, processing C, processing D, and processing E, it is only necessary for the change unit 4023 to try to make a change to the environment different from the environment in which the image has been captured by trying to perform the processing content in a predetermined order (for example, processing A, processing B, processing C, processing D, and processing E) or a random order in the processing of step S4 of the processing flow shown in FIG. 6.

### (Advantage)

As described above, the robot system 1 according to the second example embodiment of the present disclosure has been described. In the robot system 1, the change unit 4023 performs first processing content in a case where the identification unit 4021 has not identified the type of the physical object indicated in the image acquired by the acquisition unit 401 and performs second processing content different from the first processing content in a case where the identification unit 4021 has not identified the type of the physical object from an image obtained by capturing the target object after the first processing content is performed.

According to this robot system 1, in a case where the type of processing content is small, an environment in which the imaging device 202 captures a physical object can easily be changed without preparing a learned model or the like in advance. Due to this change in the environment, the image of the physical object captured by the imaging device 202 changes. As a result, the image of the physical object captured by the imaging device 202 is likely to be improved to the extent that the physical object can be identified.

### Modified Example of Second Example Embodiment

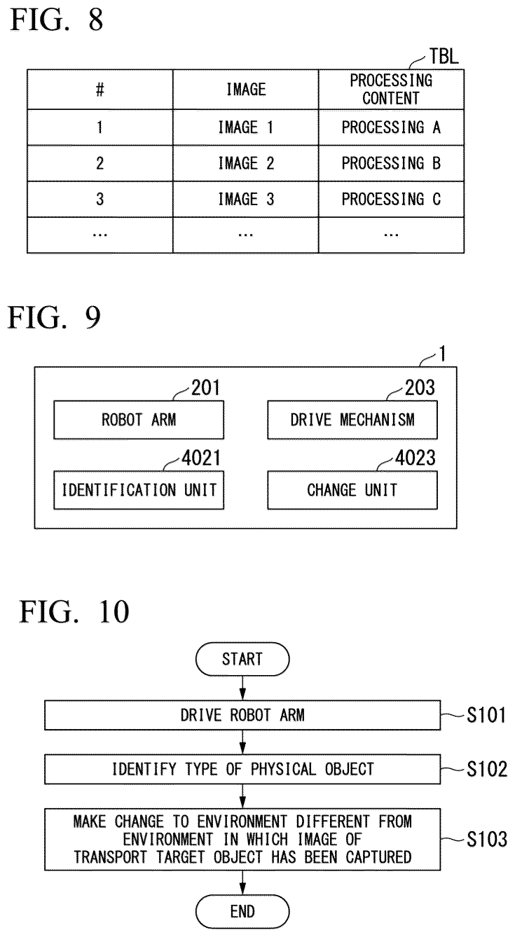

Next, a robot system 1 according to a modified example of the second example embodiment of the present disclosure will be described. The robot system 1 according to a modified example of the second example embodiment includes a transport device 10, a robot 20, an illumination device 30, and a processing device 40 like the robot system 1 according to the second example embodiment. The processing device 40 includes an acquisition unit 401 and a processing unit 402 like the processing device 40 according to the second example embodiment of the present disclosure. The processing unit 402 includes an identification unit 4021 (an example of an identification means), a control unit 4022, and a change unit 4023 (an example of a change means) like the processing unit 402 according to the second example embodiment of the present disclosure. In the second example embodiment of the present disclosure, the change unit 4023 for trying to perform the processing content by trial and error has been described. However, in the modified example of the second example embodiment of the present disclosure, the change unit 4023 may predict processing content based on an image of a physical object captured by an imaging device 202 using an image processing method different from a method using the learned model in a case where the identification unit 4021 has not identified the type of the physical object indicated in the image acquired by the acquisition unit 401. FIG. 8 is a diagram showing an example of a data table TBL in a modified example of the second example embodiment of the present disclosure. For example, the data table TBL in which the image and the processing content are associated of a case where the type of the physical object indicated in the image acquired by the acquisition unit 401 cannot be identified by the identification unit 4021 as shown in FIG. 8 is prepared. The change unit 4023 compares an image of a case where the identification unit 4021 has not identified the type of the physical object indicated in the image acquired by the acquisition unit 401 with each image in the data table TBL. Also, in the data table TBL, the change unit 4023 identifies an image closest to the image of the case where the identification unit 4021 has not identified the type of the physical object indicated in the image acquired by the acquisition unit 401. For example, the change unit 4023 compares parts of the images and identifies an image with the largest number of matches as the closest image. The change unit 4023 identifies the processing content associated with the identified image in the data table TBL. Also, it is only necessary for the change unit 4023 to perform the identified processing content.

### (Advantage)

As described above, the robot system 1 according to a modified example of the second example embodiment of the present disclosure has been described. In the robot system 1, in a case where the identification unit 4021 has not identified the type of the physical object indicated in the image acquired by the acquisition unit 401, the change unit 4023 predicts processing content based on an image of a physical object captured by the imaging device 202 using an image processing method different from the method using the learned model.

In addition, in another example embodiment of the present disclosure, the imaging device 202 may not be provided on a robot arm 201. For example, the imaging device 202 may be provided above a tray T.

According to this robot system 1, the change unit 4023 can identify processing content with a high possibility as compared with a case where the processing content is tried to perform by trial and error. The change unit 4023 changes an environment in which the imaging device 202 captures the physical object based on the identified processing content. Due to this change in the environment, the image of the physical object captured by the imaging device 202 changes. As a result, the image of the physical object captured by the imaging device 202 is likely to be improved to the extent that the physical object can be identified.

The robot system 1 having a minimum configuration according to the example embodiment of the present disclosure will be described. FIG. 9 is a diagram showing the robot system 1 having the minimum configuration according to the example embodiment of the present disclosure. The robot system 1 having the minimum configuration according to the example embodiment of the present disclosure includes a robot arm 201, a drive mechanism 203 (an example of a drive means), the identification unit 4021 (an example of an identification means), and the change unit 4023 (an example of a change means). The robot arm 201 can grasp a target object including a packaging member with transparency and a physical object packaged by the packaging member. The robot arm 201 can be implemented, for example, using functions of the robot arm 201 exemplified in FIG. 1. The drive mechanism 203 drives the robot arm 201. The drive mechanism 203 can be implemented, for example, using the functions of the drive mechanism 203 exemplified in FIG. 1. The identification unit 4021 identifies a type of a physical object based on image processing on the image of the target object. The identification unit 4021 can be implemented, for example, using the functions of the identification unit 4021 exemplified in FIG. 4. In a case where the identification unit 4021 has not identified the type of the physical object, the change unit 4023 makes a change to an environment different from the environment in which the image of the target object has been captured. The change unit 4023 can be implemented, for example, using the functions of the change unit 4023 exemplified in FIG. 4.

Next, a process of the robot system 1 having the minimum configuration will be described. FIG. 10 is a flowchart showing an example of a processing flow of the robot system 1 having the minimum configuration. Here, the process of the robot system 1 having the minimum configuration will be described with reference to FIG. 10.

The robot arm 201 can grasp a target object including a packaging member with transparency and a physical object packaged by the packaging member. The drive mechanism 203 drives the robot arm 201 (step S101). The identification unit 4021 identifies the type of the physical object based on image processing on an image of the target object (step S102). In a case where the identification unit 4021 has not identified the type of the physical object, the change unit 4023 makes a change to an environment different from the environment in which the image of the target object has been captured (step S103). Thereby, the robot system 1 can change the environment in which the physical object packaged by the packaging member with transparency is captured to an environment in which an image for identifying the physical object can be captured. As a result, the robot system 1 can appropriately and accurately recognize the physical object even if the physical object is packaged by the packaging member with transparency.

Also, in the process in the example embodiment of the present disclosure, the order of processing may be swapped in a range in which the appropriate process is performed.

Although example embodiments of the present disclosure have been described, the above-described robot system 1, the robot 20, the processing device 40, and other control devices may include a computer device therein. The process of the above-described processing is stored on a computer-readable recording medium in the form of a program, and the above process is performed by the computer reading and executing the program. A specific example of the computer is shown below.

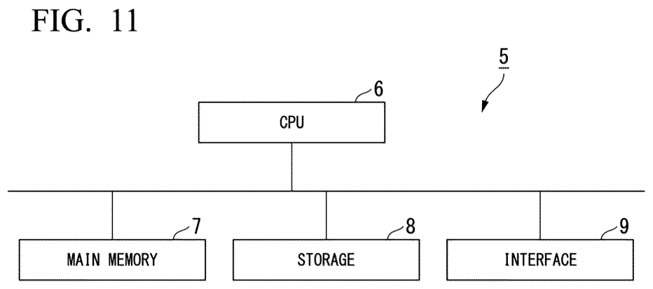

FIG. 11 is a schematic block diagram showing a configuration of a computer according to at least one example embodiment. As shown in FIG. 11, a computer 5 includes a central processing unit (CPU) 6, a main memory 7, a storage 8, and an interface 9. For example, each of the robot system 1, the robot 20, the processing device 40, and other control devices described above is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication lines. Also, in a case where the above program is distributed to the computer 5 via a communication lines, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

Although some or all of the above-described example embodiments may also be described as in the following supplementary notes, the present disclosure is not limited to the following supplementary notes.

### (Supplementary Note 1)

A robot system including:
a robot arm configured to be able to grasp a target object including a packaging member with transparency and a physical object packaged by the packaging member;
a drive means configured to drive the robot arm;
an identification means configured to identify a type of the physical object based on image processing on an image of the target object; and
a change means configured to make a change to an environment different from an environment in which the image of the target object has been captured in a case where the identification means has not identified the type of the physical object.

### (Supplementary Note 2)

The robot system according to Supplementary Note 1, including a capturing means configured to be able to capture the image of the target object,
wherein the change means controls the capturing means to form an angle different from an angle of the capturing means at which the image of the target object has been captured in a case where the identification means has not identified the type of the physical object.

### (Supplementary Note 3)

The robot system according to Supplementary Note 1, including an illumination means configured to illuminate the target object,
wherein the change means makes a change to a state of light different from a state of light radiated to the target object in a state in which the image of the target object has been captured in a case where the identification means has not identified the type of the physical object.

### (Supplementary Note 4)

The robot system according to Supplementary Note 3, wherein the change means controls the illumination means to form an angle different from the angle of the light in the state in which the image of the target object has been captured in a case where the identification means has not identified the type of the physical object.

### (Supplementary Note 5)

The robot system according to Supplementary Note 3, wherein the change means causes a physical object, which changes a refractive index of light between the target object and the illumination means, to move in a case where the identification means has not identified the type of the physical object.

### (Supplementary Note 6)

The robot system according to Supplementary Note 5, including a second robot arm separate from the robot arm,
wherein the change means causes the second robot arm to move between the target object and the illumination means in a case where the identification means has not identified the type of the physical object.

### (Supplementary Note 7)

The robot system according to Supplementary Note 1, wherein the change means controls the drive means so that a state of the physical object changes in a case where the identification means has not identified the type of the physical object.

### (Supplementary Note 8)

The robot system according to Supplementary Note 7, wherein the change means controls the drive means so that an orientation of the target object changes in a case where the identification means has not identified the type of the physical object.

### (Supplementary Note 9)

The robot system according to Supplementary Note 7, wherein the change means controls the drive means so that a state of the packaging member changes in a case where the identification means has not identified the type of the physical object.

### (Supplementary Note 10)

The robot system according to Supplementary Note 9, wherein the change means controls the drive means so that swelling of the packaging member is suppressed in a case where the identification means has not identified the type of the physical object.

### (Supplementary Note 11)

The robot system according to Supplementary Note 9, wherein the change means controls the drive means so that the packaging member is extended in a case where the identification means has not identified the type of the physical object.

### (Supplementary Note 12)

The robot system according to any one of Supplementary Notes 1 to 11, wherein the change means makes a change to an environment different from an environment in which the image of the target object has been captured based on a learned model in which a coefficient has been decided in a supervised learning method in a case where the identification means has not identified the type of the physical object.

### (Supplementary Note 13)

The robot system according to Supplementary Note 12, wherein the change means changes the learned model based on the environment that has changed and makes the change to the environment different from the environment in which the image of the target object has been captured based on the learned model after the change.

### (Supplementary Note 14)

The robot system according to any one of Supplementary Notes 1 to 11, wherein the change means performs first processing content in a case where the identification means has not identified the type of the physical object and performs second processing content different from the first processing content in a case where the identification means has not identified the type of the physical object from an image obtained by capturing the target object after the first processing content is performed.

### (Supplementary Note 15)

A processing method to be performed by a robot system including a robot arm configured to grasp a target object including a packaging member with transparency and a physical object packaged by the packaging member, the processing method including:
driving the robot arm;
identifying a type of the physical object based on image processing on an image of the target object; and
making a change to an environment different from an environment in which the image of the target object has been captured in a case where the identification means has not identified the type of the physical object.

### (Supplementary Note 16)

A recording medium storing a program for causing a computer, which is provided in a robot system including a robot arm configured to grasp a target object including a packaging member with transparency and a physical object packaged by the packaging member, to:
drive the robot arm;
identify a type of the physical object based on image processing on an image of the target object; and
make a change to an environment different from an environment in which the image of the target object has been captured in a case where the identification means has not identified the type of the physical object.

### (Supplementary Note 17)

A robot system including:
a robot arm; and
a control means configured to control an operation of the robot arm so that the robot arm performs an operation on a target object based on a result of recognizing an image obtained from an imaging device capturing the target object,
wherein the target object is a physical object packaged by a packaging member with transparency, and
wherein the control means controls the robot arm so that an environment in which the imaging device images the target object is changed in a case where the physical object has not been identified from the image.

### INDUSTRIAL APPLICABILITY

According to each example aspect of the present disclosure, even if a physical object (e.g., a product) is packaged by a packaging member with transparency, the physical object can be appropriately and accurately recognized.

### REFERENCE SIGNS LIST

1 Robot system
5 Computer
6 CPU
7 Main memory
8 Storage
9 Interface
10 Transport device
20 Robot
30 Illumination device
40 Processing device
101 Transport mechanism
201 Robot arm
202 Imaging device
203 Drive mechanism
401 Acquisition unit
402 Processing unit
DB Database
T Tray
TBL Data table

What is claimed is:

1. A robot system comprising:
a robot arm configured to be able to grasp a target object including a packaging member with transparency and a physical object packaged by the packaging member;
a memory configured to store instructions; and
a processor configured to execute the instructions to:
identify a type of the physical object based on image processing on an image of the target object; and
make a change to an environment different from an environment in which the image of the target object has been captured in a case where the type of the physical object has not been identified.

2. The robot system according to claim 1, comprising a camera configured to be able to capture the image of the target object,
wherein the processor is configured to control the camera to form an angle different from an angle of the camera at which the image of the target object has been captured in a case where the type of the physical object has not been identified.

3. The robot system according to claim 1, comprising an illuminator configured to illuminate the target object,
wherein the processor is configured to make a change to a state of light different from a state of light radiated to the target object in a state in which the image of the target object has been captured in a case where the type of the physical object has not been identified.

4. The robot system according to claim 3, wherein the processor is configured to control the illuminator to form an angle different from the angle of the light in the state in which the image of the target object has been captured in a case where the type of the physical object has not been identified.

5. The robot system according to claim 3, wherein the processor is configured to cause a physical object, which changes a refractive index of light between the target object and the illuminator, to move in a case where the type of the physical object has not been identified.

6. The robot system according to claim 5, comprising a second robot arm separate from the robot arm,
wherein the processor is configured to cause the second robot arm to move between the target object and the illuminator in a case where the type of the physical object has not been identified.

7. The robot system according to claim 1, wherein the processor is configured to control the robot arm so that a state of the target object changes in a case where the type of the physical object has not been identified.

8. The robot system according to claim 7, wherein the processor is configured to control the robot arm so that an orientation of the target object changes in a case where the type of the physical object has not been identified.

9. The robot system according to claim 7, wherein the processor is configured to control the robot arm so that a state of the packaging member changes in a case where the type of the physical object has not been identified.

10. The robot system according to claim 9, wherein the processor is configured to control the robot arm so that swelling of the packaging member is suppressed in a case where the type of the physical object has not been identified.

11. The robot system according to claim 9, wherein the processor is configured to control the robot arm so that the packaging member is extended in a case where the type of the physical object has not been identified.

12. The robot system according to any one of claims 1 to 11, wherein the processor is configured to make a change to an environment different from an environment in which the image of the target object has been captured based on a learned model in which a coefficient has been decided in a supervised learning method in a case where the type of the physical object has not been identified.

13. The robot system according to claim 12, wherein the processor is configured to change the learned model based on the environment that has changed and makes the change to the environment different from the environment in which the image of the target object has been captured based on the learned model after the change.

14. The robot system according to claim 1, wherein the processor is configured to perform first processing content in a case where the type of the physical object and performs second processing content different from the first processing content in a case where the type of the physical object has not been identified from an image obtained by capturing the target object after the first processing content is performed.

15. A processing method to be performed by a robot system including a robot arm configured to be able to grasp a target object including a packaging member with transparency and a physical object packaged by the packaging member, the processing method comprising:
driving the robot arm;
identifying a type of the physical object based on image processing on an image of the target object; and
making a change to an environment different from an environment in which the image of the target object has been captured in a case where the type of the physical object has not been identified.

16. (canceled)

17. A robot system comprising:
a robot arm; and
a memory configured to store instructions; and
a processor configured to execute the instructions to:
control an operation of the robot arm so that the robot arm performs an operation on a target object based on a result of recognizing an image obtained from an camera capturing the target object,
wherein the target object is a physical object packaged by a packaging member with transparency, and
wherein the processor is configured to control the robot arm so that an environment in which the camera captures the target object is changed in a case where the physical object has not been identified from the image.
